(19) United States
(12) Patent Application Publication
(10) Pub. No.: US 2024/0127307 A1
(43) Pub. Date: Apr. 18, 2024

(54) System, Apparatus And Method For Intelligent Product Scanner

(71) Applicant: Tania Pickering, Belmont (AU)

(72) Inventor: Tania Pickering, Belmont (AU)

(21) Appl. No.: 18/487,150

(22) Filed: Oct. 16, 2023

(30) Foreign Application Priority Data
Oct. 17, 2022 (AU) 2022256091

(51) Int. Cl. G06Q 30/0601

(52) U.S. Cl. CPC G06Q 30/0623; G06Q 30/0643

(57) ABSTRACT

The invention generally relates to systems, devices and methods of product scanning technologies designed to process product information data requests and provide an optimal, contextual product information data response. According to one embodiment, it is provided a scanning device comprising a camera and a display, the device being coupled to a data communication network to transmit a scanned product encoding to a remote network for analysis and response with a suitable product information data. In another embodiment, a suitable data processing network receives scanned product encoding to determine an associated product and the scan context based on some metric, and using a machine learning algorithm, determine a product information data suited to the context, such as marketing data, product illustration or product use data. Accordingly, products may have a scannable encoding, and a plurality of product information data based on context including but not limited to marketing, explainer, technical data among others.

### FIELD OF INVENTION

The present invention generally relates to systems, devices and methods of product scanning technologies designed to process product information data requests and provide an optimal response. The invention further relates to the use of data processing systems based on machine learning to contextually process product scans and offer a contextual product information, for example based on the location of the scan, the use of product or some other metric.

### BACKGROUND OF THE INVENTION

To most people, purchasing products can be difficult, especially deciding between a variety of seemingly similar options such as lawn mowers, vacuum cleaners, appliances and other such items. For most part, what is displayed at physical stores is a price tag, a product name and where lucky, some technical data sheet may be provided as a label on the product. To obtain further product information and in a specified context is not possible using current technology. For instance, for product demonstrations on its use, one would need to conduct a separate search on the internet and sift through tens or hundreds of possible information sources before finally getting one suited to the particular context, which for example may be product technical breakdown. The problem is exacerbated when there is need to compare a variety of choices, or to determine the best product in a category.

To address the above-cited problem, internet search engines and user guides may provide help with specific topics that are relevant to the context, such as websites providing technical data sheets. This would greatly benefit purchasers of products, as it allows them to make informed decisions. However, search engines are not able to process complex queries (more than a few keywords), and therefore, users often resort to sorting by “related results”.

Moreover, the only way to determine or compare products is by conducting multiple searches and trying to analyze and compare results, mostly from diverse sources for each product. The problem with search engines is that they do not always provide the best results, and they are not tailored to a user's context. As a result, users often resort to sorting by “related results”.

However, not all items would pass through one's mind when searching for a specific item (e.g. “product technical breakdown”), as other factors preoccupy the user such as promotions or discounts. In addition, the result list is messy and hard to understand for novice users. It is also costly and time-consuming for the end user to search each of these sites based on their own needs or interests. This, in addition to the fact that it is not always feasible to do an internet search for a product in all instances, for example, when in a store.

In addition, some website categories are not easily understood by non-native users of the language. This is especially the case for complex products where many technical terms are used. This is a real barrier to foreign users trying to obtain information about products from foreign websites, such as Chinese users looking for product information on English sites, or English speakers looking for product information on Japanese websites.

It would be an effective solution if product decision-making could be assisted by a dedicated product information data source that allows and processes queries representing users' intent, and returns the most relevant results based on it. The system should also be capable of processing more than one query at the same time in order to provide more choices to users, as well as to enable the comparison of products with respect to different features.

Search engines do not effectively capture users' intent in a specific situation and are therefore inadequate for this purpose. However, by using a product information data source tailored for a specific purpose (for instance, purchasing products) coupled to a scanning system, the above problems can be effectively addressed.

The dedicated system may also provide benefits to website owners. A product information data source developed specifically for searching a product information data source pertaining certain topic (e.g. purchasing products) in a specific context (e.g. product purchase scenarios) will enable website owners to provide rich and intelligent search results by tailoring the search engine to these specific requirements. The system may also increase a website's credibility and relevance to customers as a result of adding useful options for them, including shopping cart navigation (e.g. showing product information on products on the same page), group catalogs, and advanced site navigation tools. A dedicated system may provide for purchasing the best fit product on a dedicated website or store.

It is thus an object of this disclosure to describe a system for product information search using scannable codes on products, designed for specific contexts, which can help users efficiently obtain product information on demand, saving them the cost and time of manually searching for product information from different sources.

It is an objective of the invention to describe a data processing system based on machine learning to contextually process product scans and offer a contextual product information, for example based on the location of the scan, the use of product or some other metric.

### SUMMARY OF THE INVENTION

The following summary is an explanation of some of the general inventive steps for the system, method, devices and apparatus in the description. This summary is not an extensive overview of the invention and does not intend to limit its scope beyond what is described and claimed as a summary.

The present invention generally relates to systems, devices and methods of product scanning technologies designed to process product information data requests and provide an optimal and contextual product data response.

According to one embodiment, it is provided a scanning device comprising a camera or some other scanning device and a display, the device being coupled to a data communication network to transmit a scanned product encoding to a remote network for analysis and response with a suitable product information data. Wherein, it is anticipated that the scanning device may be a portable computing device such as a smartphone, or even a wearable smart glass or headset or watch or chip or any such.

In another embodiment, a suitable data processing network receives scanned product encoding to determine an associated product and the scan context based on some metric, and using a machine learning algorithm, determine a product information data suited to the context, such as marketing data, product illustration, product use etc.

In another embodiment, the machine learning algorithm may determine the most suitable product information data response based on a context, where the context may be analyzed and an approximation on the most suitable response established based on a graded criteria.

In one aspect, products may have a scannable encoding, and a plurality of product information data based on context including marketing, explainer videos, technical data among others.

In one aspect, products may have a scannable code, and a plurality of product information data based on context e.g. marketing, explainer videos, technical data among others in a product information data source.

In another aspect, the product information data source may comprise a database.

In another aspect, the product information data source may comprise an internet source including websites or any such.

In another aspect, the product information data may comprise video demonstrations, audio data or graphical images.

In another aspect, the scanning context may be derived from a portion of the scan including the product environment, location data or some other metric derivable from the scanning.

In another aspect, the scanning device may comprise a means to determine a scan environment which may be utilized as a measure of context or a basis for establishing.

In another aspect, the scanning device may be coupled to a context measuring source, such that a context data may be measured from the operating environment, or scanned object.

In another aspect, the context measuring source may be an external means coupled to the scanning device via a network, such as a remote computer or cloud platform.

### BRIEF DESCRIPTION OF THE DRAWINGS

The novel features believed to be characteristic of the illustrative embodiments are set forth in the appended claims. The illustrative embodiments, however, as well as a preferred mode of use, further objectives and descriptions thereof, will best be understood by reference to the following detailed description of one or more illustrative embodiments of the present disclosure when read in conjunction with the accompanying drawings, wherein:

FIG. 1 of the drawings illustrates a product showcase in an exemplary store.

FIG. 2 of the drawings illustrates mobile scanning device operated to scan an encoding on a product.

FIG. 3 of the drawings illustrates wearable glasses with a scanning device operated to scan an encoding on a product.

FIG. 4 of the drawings demonstrates the visualization of product data information by wearable glasses after scanning a product encoding.

FIG. 5 of the drawings is a contextual product data visualization in relation to a first activity

FIG. 6 shows a contextual product data visualization in relation to a second activity.

FIG. 7 shows a technical product data in a product illustration.

FIG. 8 shows a product being put to use in a product use case activity.

FIG. 9 shows a flow diagram for the training a machine learning algorithm for processing product information data requests and provide optimal product data response.

FIG. 10 shows a flow diagram for the use of a trained machine learning algorithm to process product information data requests and provide optimal product data response.

### DETAILED DESCRIPTION OF THE PREFERRED EMBODIMENTS

Hereinafter, the preferred embodiment of the present invention will be described in detail and reference made to the accompanying drawings. The terminologies or words used in the description and the claims of the present invention should not be interpreted as being limited merely to their common and dictionary meanings. On the contrary, they should be interpreted based on the meanings and concepts of the invention in keeping with the scope of the invention based on the principle that the inventor(s) can appropriately define the terms in order to describe the invention in the best way.

It is to be understood that the form of the invention shown and described herein is to be taken as a preferred embodiment of the present invention, so it does not express the technical spirit and scope of this invention. Accordingly, it should be understood that various changes and modifications may be made to the invention without departing from the spirit and scope thereof.

In this disclosure, the term exemplary may be construed as to mean embodiments that are provided as examples.

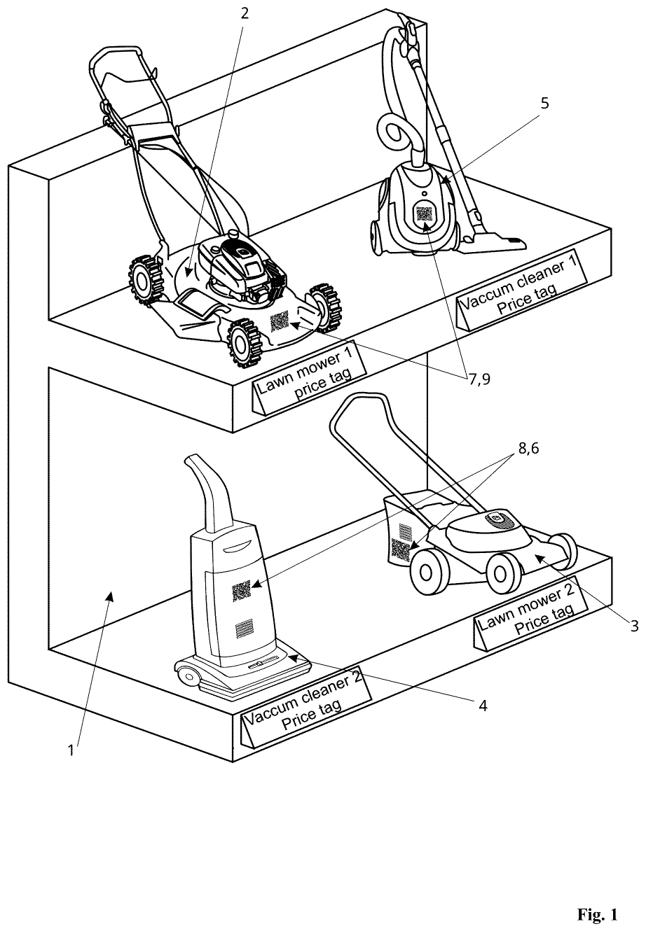

The first shown embodiment according to FIG. 1 of the drawings illustrates a product showcase in an exemplary store shelf 1. In the figure, it is shown competing products in two categories including lawn mowers and vacuum cleaners. In typical stores such as the one shown in the figure, would-be purchasers face difficulty deciding between a variety of seemingly similar options such as the shown lawn mowers 2 and 3, or vacuum cleaners 4 and 5. Usually, a store may have tens or hundreds of competing products, and typically only displays a price tag, a product name and some form of technical data sheet in the box. However, very few customers have any knowledge of interpreting technical data sheets, and thus this leaves a gap that requires to be addressed, to enable customers make proper product analysis prior to purchasing them.

For example, the lawn mower 2 may have better performance due to an improved cutting technology. Or that the lawn mower 3 may be better adapted for large scale operation as opposed to home uses. The actual handling of the respective product may also inform the decision of a customer to purchase the item or to choose a competing product, but this is not apparent from merely looking at the product on the shelf. Also illustrated in the same figures are product encoding including 6, 7, 8 and 9 on the lawn mowers 2 and 3, and vacuum cleaners 4 and 5 respectively. The encoding 6, 7, 8 and 9 on the respective product may comprise a QR code, a bar code, a string of characters, or an electromagnetic signal or any such. The encoding provides a means of identifying a specific product or product line in a database or some other product information data source including an internet source including websites, data stores or any such. This product information data source stores product information data identifiable to a respective product or product line, said product or product line identifiable to an encoding embodies by a QR code, a bar code, a string of characters, an electromagnetic signal or any such as embodied on a product. Further, the context or contexts for which product information data applies may be stored in the product information data source.

It should be noted, however, that this disclosure further anticipates that the suitable product information data may be determined, for example based on the number of hits of a particular product information data, including popularity. In addition, the context may be transmitted separately and determined prior to a scan, during a scan or after a scan, and independently of the scan itself.

The product information data may be based on a particular context. For example, this context may relate to a marketing, product explainer, technical illustration, product use, among others. Where the product information data would be provided suiting the context to allows a customer to make an informed decision on the suitability of a product before purchase, or to compare a variety of products. For example, technical illustration product information data may be suitable for comparing between different products, or even to get to know its features. A product use data may be suitable to demonstrate the product in use in a certain environment, for example, a lawn mower cutting grass on a playground. A product explainer, on the other hand may explain general characteristics of a product, its technical features and its use and may be suited to a customer generally seeking to compare products, or simply get to understand new products that they have not seen before. For example, the scanning device may be configured capable of determining the number of times a product or product line has been scanned, which may server as a contextual data point. In yet another example, having scanned products in similar product lines may point towards a context to compare the two products or product lines. These examples are not intended to limit what context means and are merely illustrative as there are many other scenarios that could play out.

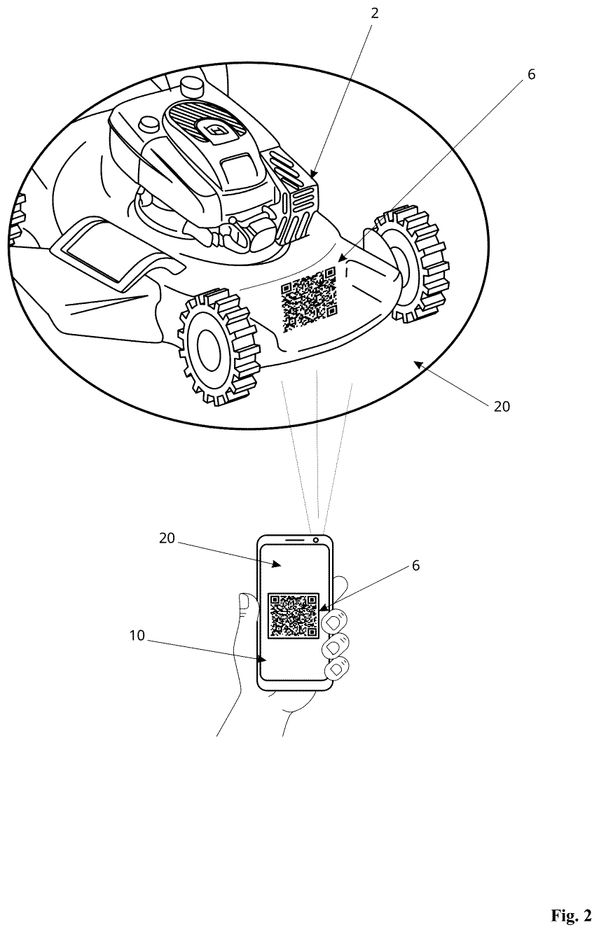

Now referring to the FIG. 2 of the drawings, it is illustrated a mobile scanning device 10 operated to scan an encoding 6 on a product 2 and additionally receive a context 20. The device has a scanner and a display, the scanner being adapted to scan the product encoding in any format including in a QR code, a bar code, a string of characters, an electromagnetic signal or any such. The device 10 may comprise one or more processors, a network interface or any means to couple to a data communication network, a display and a memory. The scanner may comprise a camera or an electromagnetic signal detector or any suitable means to scan a product encoding. A product encoding may be a serial number, a product identifier or any data identifiable to a product or product line.

The device is configured capable of transmitting the scanned encoding 6 and context data to a data processing layer via a data communication network. The data processing layer may be a computer or server or any such, configured to receive the scanned code and context data to provide a contextual product information data for outputting on the display of the scanning device.

According to some aspect, the device may be provided capable of measuring its operating environment, and using some metrics such as location data, may measure a usage context. For example, using the device to scan a product in a particular location may be related to a shopping activity since a shop is located in the general location.

In addition, and in a non-limiting embodiment, a context measuring mechanism may be provided, including but not limited to a remote computer or a computer program and data stored on device, where environment data or device operation data may be transmitted for a context measuring to respond with a context measurement.

For example, a device location data may be a measure or contributor to a measurement of context.

In another example, data stored on the device (including the products scanned, number of scanning operations performed) may be a measure or contributor to a measurement of context.

In another example, a portion of the product scanned may comprise additional data such as the product location or usage, which may be processed to measure or contribute to the measurement of context.

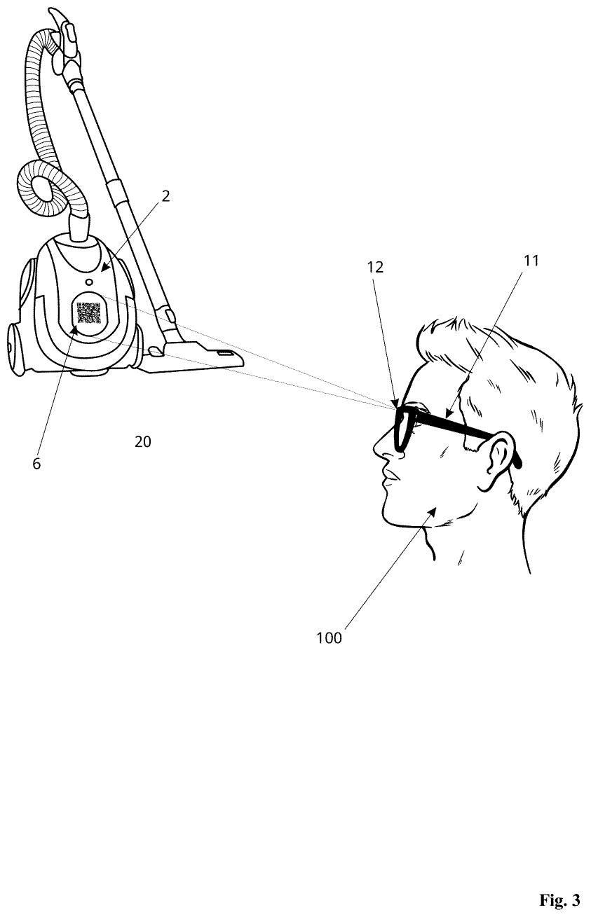

Reference is now made to FIG. 3 of the drawings, which illustrates wearable glasses 11 with a scanning device operated to scan an encoding on a product. A person 100 is shown in the figure having worn the pair of wearable glasses 11 with a scanner 12, which for purposes of this illustration, may be a camera or an electromagnetic signal detector or any suitable means to scan a product encoding within a field of view, and to receive a context for which the scan is made, either from a portion of the scan including the product environment, location data, or even determined prior to a scan, during a scan or after a scan, and independently of the scan itself. The wearable glasses 11 may comprise one or more processors, a network interface or any means to couple to a data communication network, a display which may be part of the glasses and a memory. As with the first scanning device 10, the wearable glasses 11 may also be operable to scan the product encoding 6 in any format and where applicable, the scan context, and via the network interface, transmit the scanned encoding 6 and context data to a data processing layer via a data communication network.

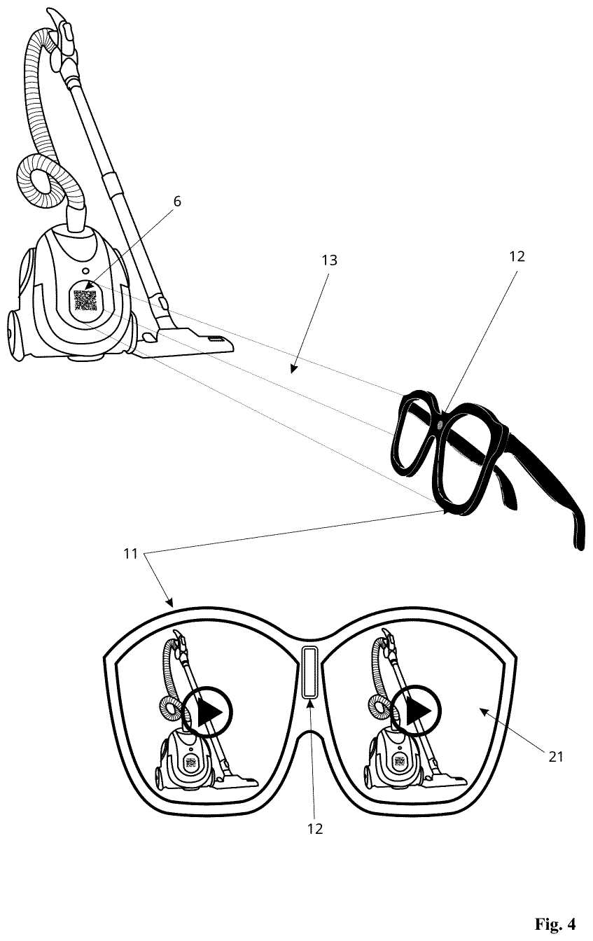

The FIG. 4 of the drawings demonstrates the visualization of product data information 21 by wearable glasses 11 after scanning a product encoding 6. In particular, the wearable glasses 11 have a field of view 13 within which a product information data 21 may be visualized. The indicated product information data 21 may relate to a particular context including a marketing, product explainer, technical illustration, product use among others. The illustration shows that the wearable glasses 11 was operable to receive a contextual product information data and outputting on the display means after transmitting the scanned code and context data to a data processing layer. The displayed data may be a graphical image, audiovisual or a video or a combination of several data formats.

In this context, and as referenced in several other figures preciously in this disclosure, the data processing layer may embody a computer or server or any such, with a memory configured with a sequence of instructions executable by the processor, all forming a data processing layer for contextually processing product information requests. Further configured as part of the data processing layer may be a trained machine learning algorithm capable of receiving a context data and determine the contextually relevant product information data. Generally, the data processing layer may be adapted to receive a transmitted product encoding (or simply code as may be referred to in this disclosure) and contextual data from the scanning device and using a trained machine learning algorithm determining contextually relevant product information data or some contextual index, where thereafter it may, using the received code as an identifier, determine the respective product from a product information data source and product information data for the respective context. The determined product information data may them be transmitted back to the scanning device for visualization on the display. This transmission may be synchronous or asynchronous, and is performed via a data communication network, which links the scanning device and the data processing layer.

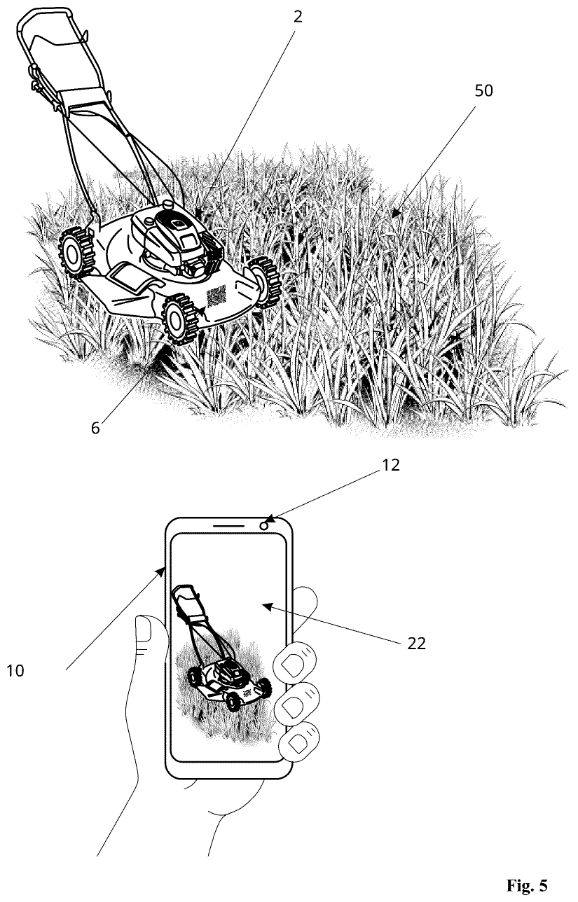

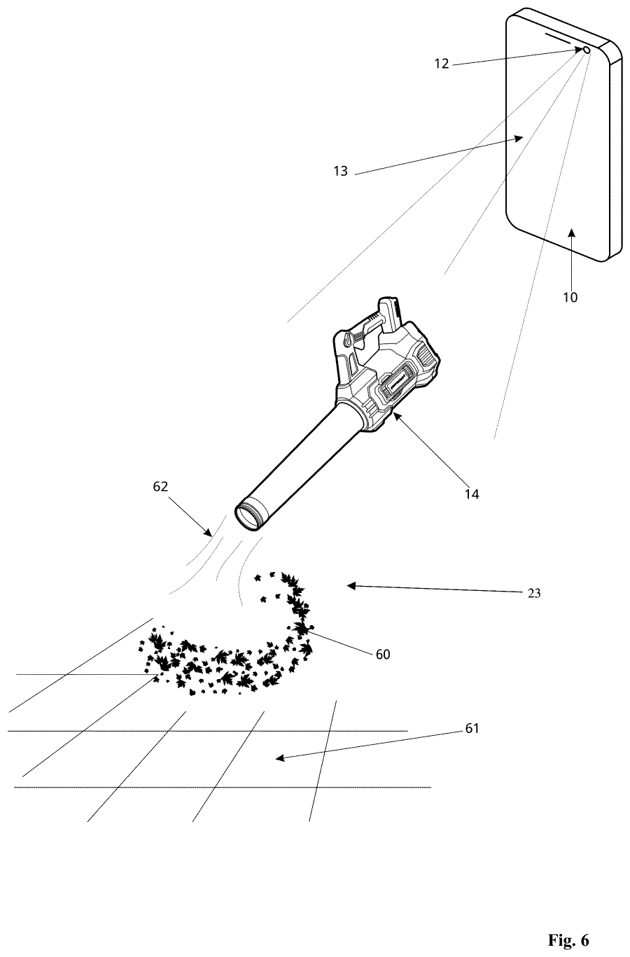

Further, and in reference to FIGS. 5 and 6, FIG. 5 of the drawings is a contextual product data visualization in relation to a first activity, while FIG. 6 shows a contextual product data visualization in relation to a second activity. In FIG. 5 a lawn mower 2 is seen in a garden 50 performing a grass cutting activity. The grass cutting activity is an example product use context that may be picked up by the scanner. A scanning device 10 with a scanner 12 scans the encoding on the lawn mower 2, transmits the encoding and the context to a data processing layer, where in response to the processing a product information data is returned for rendering and visualization on the display and in context of the scanning seen as 22 in the figure. In this context the product information data visualized may differ, for example, from where a comparison context is determined, which may require demonstrating the technical features of the compared products, or its use.

The FIG. 6 on the other hand, demonstrates a leaf blower 14 performing the task of blowing leafs 60 on a street 61. The leaf blower 14 blows a gush of air 62 towards the leafs to get them off the street in a typical product use context.

A scanning device with a scanner 12 with a filed of view 13 scans the encoding on the leaf blower 14, transmits the encoding and the context to a data processing layer, where in response to the processing a product information data is returned for rendering and visualization on the display and in context of the scanning seen as 23 in the figure.

While FIGS. 5 and 6 have demonstrated how context may be derived to inform the correct product information data, the examples are merely illustrative and do not intend to limit what may be understood as context. In an example, scanning two product encoding for similar but competing products may be determined as a product comparison context. Randomly scanning multiple products may be determined as sampling/window-shopping context and thus offer marketing data for visualization. Other scenarios are equally anticipated.

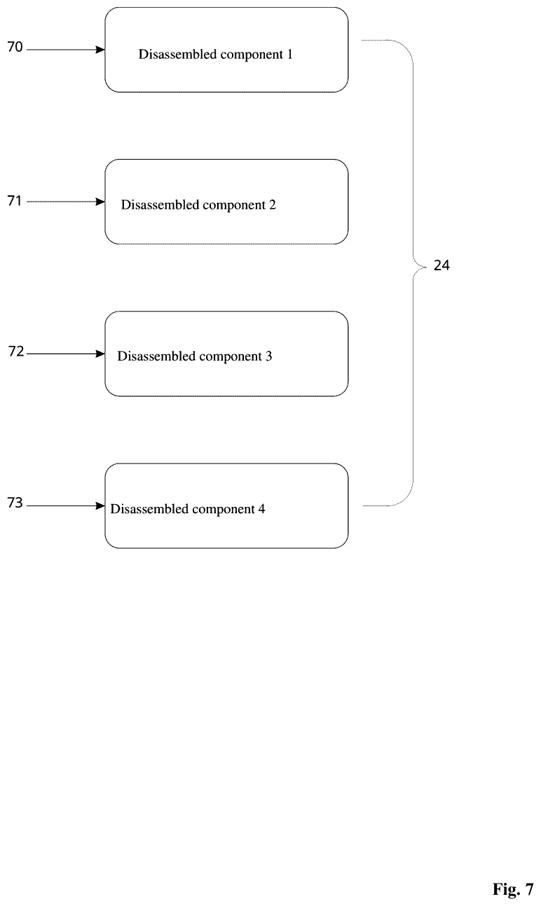

In another embodiment according to FIG. 7 of the drawings, it is shown a technical product data in a product illustration. An exploded view 24 of the exemplary product is shown, and comprising assembled parts 70, 71, 72 and 73. this product could be a lawn mower, a vacum cleaner, a television, a refrigerator or any other product. This product illustration may be presented in graphical format, video demonstrated or audiovisual format, and may be adapted for particular scan contexts such as product illustration, or other contexts.

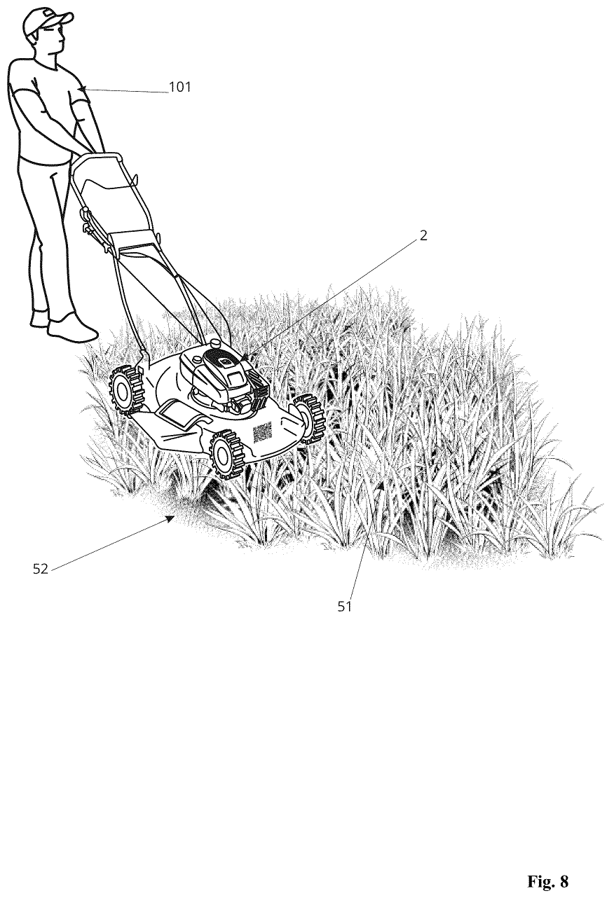

The FIG. 8 shows a product being put to use in a product use case activity. In the illustration, a person 101 is seen using a lawn mower 2 on an exemplary field 52 to cut grass 51. the product use illustration may be adapted for a particular scan context, one or more contexts.

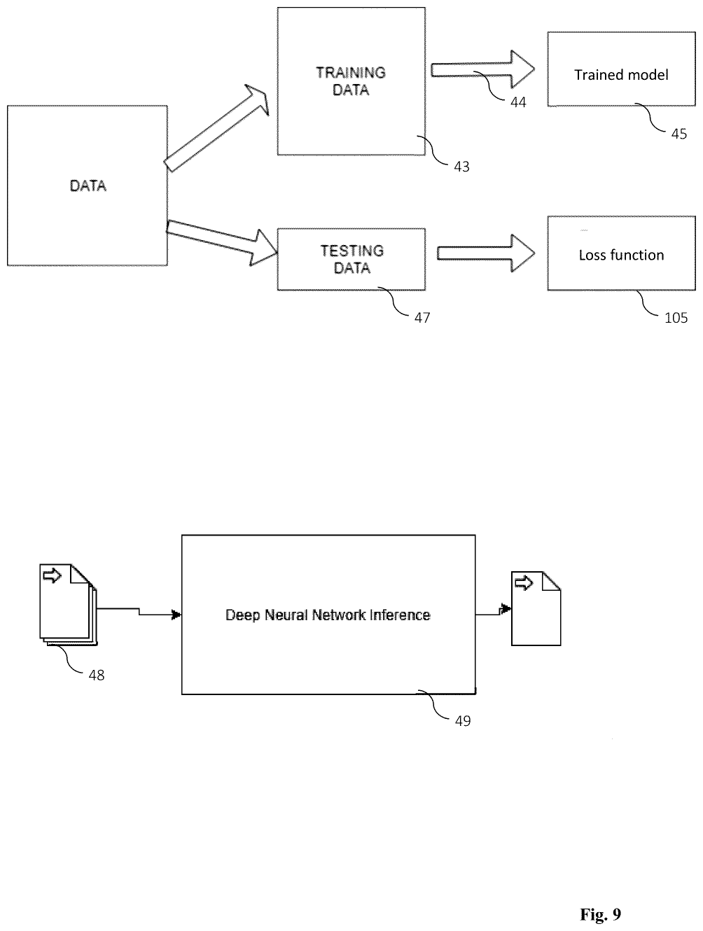

Reference is now made to FIG. 9, which shows a flow diagram for the training a machine learning algorithm for processing product information data requests and provide optimal product data response. On the figure, it is shown a training data set 43 being fed into an untrained machine learning algorithm capable of pattern recognition 44 of provided data in the training data set 43. The training data may comprise product scans, the context under which they happened and the subsequent product information data visualized. This is used for training one or more models 45 based on the patterns determined from the dataset by the machine learning algorithm.

Generally, training in this context may comprise providing the training data set comprising product scans, context and the corresponding product information data and using an untrained algorithm, extracting patterns to correlate the data points in the training data set. The process leads to the output of a prediction model comprising an extracted pattern correlating to product scans, context and the corresponding product information data in a dataset.

There may be further a need for further retraining and/or validation of accuracy of the previously trained model as in 46 using a validation dataset 47. Typically, the validation determines the accuracy of the trained model (e.g. by determining a loss function 105) by attempting to product information data through product scans and the context under which they happened, this being data provided in the validation data set.

Thereafter, a trained model may be deployed in the real world where product encoding scans, and context data 48, may be passed through a trained (and/or validated model) for classification and and processing 49 for the determination of product information data contextually 50. In this context, it is anticipated that the preferred algorithm for the machine learning algorithm may be any algorithm with an acceptable accuracy, and this may include a Convolution Neural Network, other neural networks, classifiers, Statistical algorithm, Structural algorithms, Template matching algorithms, Fuzzy-based algorithms, Hybrid algorithms, Deep Neural Networks, Feature Space Augmentation & Auto-encoders, Generative Adversarial Networks (GANs), and Meta-Learning among others.

According to one aspect, the classification and processing 49 performed by a trained model may be performed in several steps, which may include the receiving of a product encoding scan and contextual data, and thereafter, the determining by the trained model a contextual product information data to visualize by the scanning device.

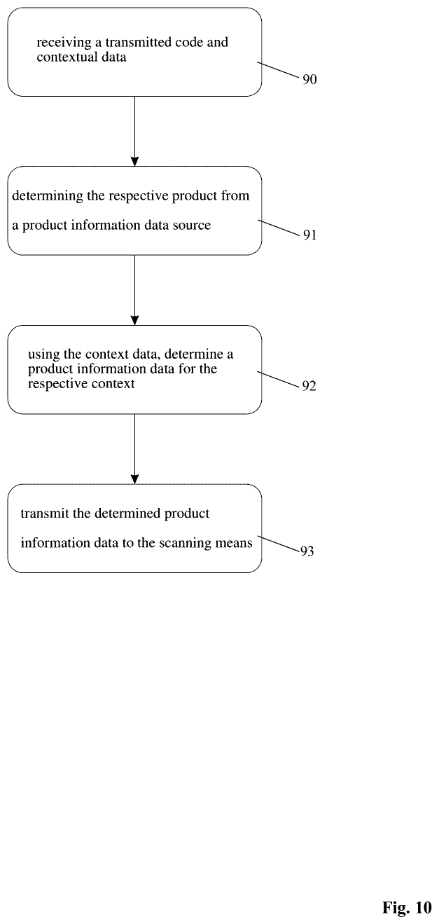

The last shown embodiment as in FIG. 10 is a flow diagram for the use of a trained machine learning algorithm to process product information data requests and provide optimal product data response. In the step 90, it may be operable by receiving a transmitted code and contextual data from the scanning means. Thereafter in the step 91, using the received code as an identifier, determining the respective product from a product information data source. Further, in step 92, using the context data, determining by a suitably trained machine learning algorithm a product information data for the respective context. Subsequently, in step 93, it may be operated to transmit the determined product information data to the scanning means.

According to one embodiment, based on a context data, the machine learning may run a scoring algorithm to score the context data against possible known contexts, and deriving a score in percentage. In this non-limiting embodiment, the product information data in the highest scoring context or contexts may be determined as the most contextual product information data responses.

According to one embodiment, measurement of the context may be performed against a portion of the transmitted scan, where, after extracting the code from the scanned data in image, video or electromagnetic format, the remaining data may be weighted against known contexts in percentages using an estimation algorithm model, typically well known in the art. In this example, where no obvious context is determined, the next highest scoring context may be selected as being most contextual.

According to one embodiment, various data forms collected from the scanning device including location, usage patterns, user profile, device characteristics, financial/transaction data may generally be processed by an estimation model to estimate context in a percentage against available contexts stored in a data storage device or some other source of product information data. The general training of such an estimation model is outlines in FIG. 9 of this disclosure.

According to one embodiment, the data processing system for contextually processing product information requests client/server architecture may employ a server process that sends product information data to the user's device (such as a PDA, desktop PC, or web browser). The system may operate in the background and work seamlessly with other systems.

According to one embodiment, the system may preserve data confidentiality and provide secure authentication of the user. It may use a database (such as a relational database management system) to store event sequences recorded in a calendar. It is anticipated that the some embodiments of the disclosed invention may be a system, a method, and/or a computer program product at any possible technical detail level of integration. The computer program product may include a computer readable storage medium (or media) having computer readable program instructions thereon for causing a processor to carry out aspects of the present invention.

According to one aspect, a product encoding may be substituted by a product image which may be determined as a specific product in a product information data store. In this regard, the scanner may take images of the product and transmit it to the data processing layer.

According to one aspect, context data may be stored on a storage device of a scanning device, and transmitted with the scanned encoding or image to the data processing layer. In this context,

It is anticipated that blocks in flowchart illustrations and/or block diagrams, and combinations of blocks in the flowchart illustrations and/or block diagrams, can be implemented by computer readable program instructions.

It is further anticipated that where computer readable program instructions are provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. As such, computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

Although a preferred embodiment of the present invention has been described for illustrative purposes, those skilled in the art will appreciate that various modifications, additions and substitutions are possible, without departing from the scope and spirit of the invention as disclosed in the accompanying claims. Such alterations are herewith anticipated.

Accordingly, the applicant intends to embrace all such alternatives, modifications, equivalents and variations that are within the spirit and scope of the disclosed subject matter. It should also be understood that references to items in the singular should be understood to include items in the plural, and vice versa, unless explicitly stated otherwise or clearly from the context. Grammatical conjunctions are intended to express any and all disjunctive and conjunctive combinations of conjoined clauses, sentences, words, and the like, unless otherwise stated or clear from the context. Thus, the term “or” should generally be understood to mean “and/or” and so forth.

### INDUSTRIAL APPLICATION

The invention is applicable in the computing industry, specifically data processing systems.

What is claimed is:

1. A data processing system for contextually processing product information data requests, the system comprising of:
a scanning means comprising at least a processor, a memory, a scanner, a display means and being operably coupled to a data processing layer by a network, the scanning means being operable to scan a product and provide identifiable product and context data to the data processing layer, and further operable to receive a contextual product information data from the data processing layer and output the contextual product information data on the display means;
a data processing layer comprising at least a memory, at least a processor, and including a suitably trained machine learning algorithm and comprising a sequence of instructions configured on memory and executable by at least a processor, the execution of which causes:
receiving provided identifiable product and contextual data from the scanning means;
using the received identifiable product data, extracting a product identifier and determine the respective product from a product information data source;
using the context data, determining by a suitably trained machine learning algorithm a product information data for the respective context; and
providing the determined contextual product and product information data to the scanning means;
a network; and
a product information data store being provided for storing product identifier data for respective products and storing a plurality of product information data for respective products, wherein, each product information data corresponds to a context data input of the scanning means, and wherein, the context is determined by the suitably trained machine learning algorithm.

2. The data processing system of claim 1, wherein the product information data store comprises a database storing data thereon, or links to product information data.

3. The data processing system of claim 1, wherein the product information data source is an internet source including web sites or any such.

4. The data processing system of claim 1, wherein the product information data comprises a video demonstration.

5. The data processing system of claim 1, wherein the product information data is a graphical image.

6. The data processing system of claim 1, wherein the context data is derived from a portion of the scan including the product environment and any such.

7. The data processing system of claim 1, wherein the context data is derived from location data derived from the scanning means.

8. The data processing system of claim 1, wherein the product information data comprises marketing data, product explainer, technical illustration, and/or product use data.

9. The data processing system of claim 1, wherein the context data is pre-programmed into the scanning means.

10. A scanning device adapted for processing product information requests, the device comprising of:
a product scanner;
at least a processor;
a display;
at least a memory configured with a sequence of instructions executable by said at least a processor, which when executed causes the implementation of a method comprising:
scanning a product to obtain identifiable product and context data;
providing the scanned identifiable product data and context data to a data processing layer;
receiving a contextual product information data; and
outputting the received contextual product information data on the display, wherein, the processing of the identifiable product data and context data by the data processing layer comprises the steps of:
receiving provided identifiable product data and contextual data from the scanning device;
using the received identifiable product data, determining the respective product from a product information data store, wherein the product information data store is provided for storing product identifier data for respective products and storing a plurality of product information data for respective products;
using the context data for the determined product, determining by a suitably trained machine learning algorithm a product information data for the respective context, wherein, each product information data corresponds to a context data input of the scanning means, and wherein, the context is determined by the suitably trained machine learning algorithm; and
providing the determined product and product information data to the scanning device.

11. The scanning device of claim 10, wherein the device embodies a wearable headset.

12. The scanning device of claim 10, wherein the device embodies a mobile handset.

13. A computer program comprising a sequence of instructions configured on a memory and executable by at least a processor of a computing device, which when the program is executed by a computer, causes the implementation of a method for contextually processing product information requests, the method comprising:
receiving identifiable product and contextual data from a scanning means; using the received identifiable product data, determining the respective product from a product information data store, wherein the product information data store is provided for storing product identifier data for respective products and storing a plurality of product information data for respective products;
using the context data for the determined product, determining by a suitably trained machine learning algorithm a product information data for the respective context, wherein, each product information data corresponds to a context data input of the scanning means, and wherein, the context is determined by the suitably trained machine learning algorithm; and
transmitting the determined product and product information data to the scanning means.

14. The computer program of claim 13, wherein the product information data source comprises a database.

15. The computer program of claim 13, wherein the product information data source is an internet source including websites or any such.

16. The computer program of claim 13, wherein the product information data comprises a video demonstration.

17. The computer program of claim 13, wherein the product information data is a graphical image.

18. The computer program of claim 13, wherein the context data is derived from a portion of the scan including the product environment and any such.

19. The computer program of claim 13, wherein the context data is derived from location data derived from the scanning means.

20. The computer program of claim 13, wherein the product information data comprises marketing data, product explainer, technical illustration, and/or product use.
